(19) United States
(12) Patent Application Publication
(10) Pub. No.: US 2018/0060893 A1
(43) Pub. Date: Mar. 1, 2018

(54) CORRELATING CONSUMPTION AND ACTIVITY PATTERNS

(71) Applicant: WeissBeerger Ltd., Tel-Aviv (IL)

(72) Inventors: Oded OMER, Holon (IL); Omer AGIV, Ramat-HaSharon (IL); Gil KAPLAN, Rishon-LeZion (IL)

(21) Appl. No.: 15/685,097

(22) Filed: Aug. 24, 2017

Related U.S. Application Data
(60) Provisional application No. 62/379,321, filed on Aug. 25, 2016.

(51) Int. Cl. G06Q 30/02; G06Q 10/04; G06N 7/02; G06F 17/15; G06K 9/62; G06Q 50/12

(52) U.S. Cl. CPC G06Q 30/0205; G06Q 10/04; G06Q 30/0201; G06Q 50/12; G06F 17/153; G06K 9/6227; G06N 7/023

(57) ABSTRACT

According to an aspect of some embodiments of the present invention there is provided a method for estimating product demand at one or more target venues, comprising: receiving a plurality local parameters comprising a level of product demand, and a volume of liquid beverage dispensed by at least one liquid dispenser, illumination conditions, audible conditions, number of people in the target venue, and/or identity of staff working at the target venue, and receiving general parameters comprising time of day, date, and/or local weather conditions, substituting at least one parameter in a classifier algorithm, the classifier algorithm calculated to correlate a desired level of the demand for products with the at least one parameter, and the classifier algorithm outputting a recommendation to adapt the at least one parameter to increase the product demand.

### RELATED APPLICATIONS

This application claims the benefit of priority under 35 USC §119(e) of U.S. Provisional Patent Application No. 62/379,321 filed on Aug. 25, 2016. The contents of the above application are all incorporated by reference as if fully set forth herein in their entirety.

### FIELD AND BACKGROUND OF THE INVENTION

The present invention, in some embodiments thereof, relates to a method of estimating product demand at a target venue, and, more specifically, but not exclusively, to a method of calculating a classifier algorithm for estimating product demand of beverages at based on environmental factors.

Bars and other businesses that serve beverages can be a very profitable business. However, the actual product served to customers is often a commodity, since many businesses offer a similar array of beverages. Consumption decisions by customers can be greatly impacted by environmental factors, which are part of the “look and feel” of the business. In addition to architectural attributes, a large number of factors contribute to “look and feel”, for example lighting, ambient noise levels, and the number of people in the business. In many cases, a customer will enter a business and make a quick decision based on the “look and feel” about whether to look elsewhere a more comfortable environment.

While owners of successful businesses have some field tested experience to guide them in crafting a “look and feel”, a data driven solution to crafting a “look and feel” that optimizes sales is not available.

### SUMMARY OF THE INVENTION

According to an aspect of some embodiments of the present invention there is provided a method for estimating product demand at one or more target venues, comprising: receiving a plurality of parameters collected from at least one target venue comprising a plurality of local parameters and at least one general parameter, the local parameters comprising a level of product demand at the at least one target venue, and at least one member of a group of parameters consisting of: a volume of liquid beverage dispensed by at least one liquid dispenser, illumination conditions, audible conditions, number of people in the target venue, and identity of staff working at the target venue, the general parameter comprising at least one member of a group of parameters consisting of: time of day, date, and local weather conditions, substituting at least one the parameter in a classifier algorithm, the classifier algorithm calculated to correlate a desired level of the demand for products with the at least one parameter, and the classifier algorithm outputting a recommendation to adapt the at least one parameter to increase the product demand.

Optionally, the classifier algorithm comprises an algorithm for estimating product demand, the algorithm comprising at least one technique chosen from a set of techniques consisting of supervised machine learning, decision tree, linear classifiers, boosting, Support-Vector Machines, neural networks, nearest neighbor algorithms, logistic regression, statistical classification, statistical regression, pattern recognition, sequence labeling, and any other technique for estimating product demand levels based on a plurality of parameters correlated with product demand in the past.

Optionally, the target venue is at least one type of business chosen from a group of businesses comprising a bar, a restaurant, a kiosk, a supermarket, a grocery store, a foodstuffs store, and any other vender that offers for sale edible products.

Optionally, calculating an ambiance parameter, the calculation responsive to the illumination conditions, the audible conditions, and the number of people, and further estimating product demand level by substituting the ambiance parameter in the classifier algorithm.

Optionally, the liquid comprises at least one liquid chosen from at least one group of liquids, the groups comprising brands of beer, brands of wine, brands of whiskey, brands of spirits, and any other beverage.

Optionally, the level of product demand comprises at least one form of sales data chosen from a group of sales data consisting of point of sales (POS), cash register records, written receipts, ecommerce transactions, cell phone enabled purchases, smart credit card purchases, and any other record of sales transactions.

Optionally, the levels of product demand comprises time stamped records of payment for products purchased and records of when the purchased products were ordered.

Optionally, the change in number of people is calculated automatically by acquiring and analyzing output of a sensor indicative of a change in the number of people, wherein recognition techniques are employed to identify individuals, employing at least one technique from a group of techniques comprising facial recognition, pattern recognition, voice recognition, shape recognition, color recognition, thermal recognition, wireless recognition of a mobile communication device, and any other technology for automatically identifying a person.

Optionally, using the recognition technique to calculate an amount of time each individual dwells in the target venue.

Optionally, further comprising calculating an attractiveness parameter, the calculation responsive to the change in number of people and the amount of time individuals dwell, and further estimating product demand level by substituting the attractiveness parameter in the classifier algorithm.

Optionally, a state transition corresponding to the at least one parameter recommendation is automatically initiated for at least one controllable appliance, the controllable appliance located at the at least one target venue.

Optionally, a state transition corresponding to a recommendation output by a control algorithm is automatically initiated for at least one the controllable appliance, the control algorithm correlating the state transition with a range of values of at least one the parameter.

Optionally, the at least one controllable appliance chosen from a group of appliances that have a plurality of states that may be controlled remotely, consisting of a cash register lock, a refrigerator door lock, a shut off flow valve of the liquid dispenser, an illumination device, a sound system device, a smart price tag, a low frequency radio frequency smart price tag, a computerized menu of prices for products, and any other controllable appliance in the local venue.

Optionally, more than one parameter of the plurality of local parameters may be automatically defined as belonging to a category, the category comprising a new local parameter.

According to an aspect of some embodiments of the present invention there is provided a method for calculating a classifier algorithm for estimating product demand at one or more target venues, comprising: receiving a training set comprising a computer file, the computer file comprising a plurality feature vectors, each of the plurality of feature vectors comprising a plurality of features comprising parameters collected from sensors at one or more target venues during a time segment of certain period, the plurality of features comprising at least one member of a group consisting of illumination condition changes, audible parameter changes, time of day, time limited sales promotions, air quality changes, a plurality of liquid consumption changes from at least one liquid dispenser, and levels of product demand from customers of at least one product offered for sale, defining a subset of the plurality of features, and adjusting the feature vector to include only the subset of the plurality of features, defining at least one class comprising a set of all feature vectors with corresponding the product demand level less than a maximum and greater than a minimum level, calculating from the training set a correlation between at least one the feature vector and the class, and calculating a classifier algorithm that estimates, based on the correlation, when a feature vector from a time segment of another period is a member of at least one the class.

Optionally, the classifier algorithm comprises an algorithm for estimating product demand, the algorithm comprising at least one technique chosen from a set of techniques consisting of supervised machine learning, decision tree, linear classifiers, boosting, Support-Vector Machines, neural networks, nearest neighbor algorithms, logistic regression, statistical classification, statistical regression, pattern recognition, sequence labeling, and any other technique for estimating product demand levels based on a plurality of parameters correlated with past levels of product demand.

Optionally, a user input of instructions for the calculation of the classifier algorithm, the instructions comprising at least one member chosen from a list consisting of: choosing a subset of the plurality of features from which to calculate the feature vector, choosing a time period for the training set, choosing a time segment for each of the plurality of feature vectors, choosing a the minimum and maximum sale level of the class, and defining the product demand to measure only a specific the product sold or a specific group of the products sold.

According to an aspect of some embodiments of the present invention there is provided system for estimating product demand at one or more target venues, comprising: a plurality of sensors deployed at one or more target venues, at least one sales recording device adapted to recording product demand at one or more target venues, at least one network interface device adapted to receive signals from the plurality of sensors and the sales recording device and transmit the signals as parameters, at least one server comprising: an interface adapted to acquiring and time stamping a plurality of parameters from the plurality of sensors located at or near the one or more target venue, the server interface adapted to acquiring a plurality of product demand data from the at least one the sales data recording device, one or more non-transitory computer-readable storage mediums, code instructions stored on at least one of the one or more storage mediums, one or more processors for executing the code instructions coupled to the interface and coupled to the one or more storage mediums, the code instructions comprising: code instructions for storing the plurality of parameters and the plurality of product demand data in a computer file as plurality of time stamped parameter vectors, wherein the plurality of parameters and product demand data belong to a corresponding time segment, code instructions for identifying at least one correlation between the level of product demand and at least one of the plurality of parameters in the computer files, code instructions to calculate a classifier algorithm to estimate product demand based on the correlation, and code instructions for the classifier algorithm to output a recommendation to adapt the at least one of the plurality of parameters to increase the product demand.

Optionally, the sensors comprise at least one member of a group consisting of audible level sensors, illumination level sensors, air quality sensors, sensors which indicate a change in the number of people in the one or more target venues, and liquid dispenser volume sensors.

Optionally, the sensor indicating a change in the number of people comprises at least one sensor chosen from a group of sensors comprising image sensors, video sensors, voice sensors, thermal sensors, wireless sensors for recognizing a mobile communication device, and any other type of sensor for automatically identifying a person.

Optionally, the interface comprising a user interface (UI) allowing a user to input instructions to determine calculation of the classifier algorithm, the instructions comprising at least one member chosen from a list consisting of: choosing a subset of the plurality of parameters from which to calculate the correlation, choosing a time period for the training set, choosing a time segment for each of the plurality of parameter vectors, choosing a range of the levels of product demand from which to calculate the correlation, and choosing the product demand level to include only a specific product or a specific group of products sold.

Optionally, further comprising code instructions for receiving via the interface a computer file comprising plurality of the time stamped parameter vectors.

Optionally, further comprising code instructions to transmit the at least one recommendation to at least one of a plurality of controllers, the plurality of controllers adapted to receive the at least one recommendation and to initiate a state transition on at least one controllable appliance at the one or more target venues.

Optionally, the server further comprising a smart hub comprising a wired and wireless computer networking hub, the smart hub adapted to receive, store, and transmit the transmitted parameters and the recommendations via a local area network (LAN).

Optionally, further comprising code instructions to detect the removal of a piece of equipment from the at least one target venue by the absence of a wireless signal received from a transmitter attached to the piece of equipment.

Optionally, further comprising code instructions to calculate a recommendation for a state transition of at least one controllable appliance, the calculation correlating the state transition with a range of values of at least one the parameter, and transmitting the recommendation to at least one of the plurality of controllers.

Optionally, further comprising a printing device adapted to receiving the product demand from a computing device selected from a group of devices consisting of the sales recording device, the server, and the smart hub, the printing device adapted to printing the product demand and adapted to converting the product demand into a computer file for transmission to the computing device.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a schematic illustration of an exemplary system for estimating product demand at a target venue, according to some embodiments of the present invention;

FIG. 1B is a schematic illustration of an exemplary system as shown in 1A with optional smart hub and controlling devices, according to some embodiments of the present invention;

FIG. 2 is a flowchart of an exemplary process for estimating product demand for at least one target venue, according to some embodiments of the current invention; and

FIG. 3 is a flowchart of an exemplary process for calculating a classifier algorithm for estimating product demand for at least one target venue, according to some embodiments of the current invention.

### DESCRIPTION OF SPECIFIC EMBODIMENTS OF THE INVENTION

The present invention, in some embodiments thereof, relates to a method of estimating product demand at a target venue, and, more specifically, but not exclusively, to a method of calculating a classifier algorithm for estimating product demand of beverages at based on environmental factors.

Estimating optimal conditions for sale of beverages at a business that serves drinks is a complex problem. Consumer behavior is difficult to predict since it is affected by many environmental factors, including in venue conditions, such as environmental lighting, ambient noise levels, number of customers present, air quality, types of snacks offered, and general conditions, such as time of day, day of the week, temperature, and the like. Many of these factors may have interdependent impact on sales, for example levels of sales may be more closely correlated with a combination of level of illumination and level of audible than with either factor individually. In addition, each individual customer's decision making process is affected differently by the factors and combinations of factors.

Due to this complexity, it is beyond the human ability to correlate demand for products with all possible combinations of factors. According to some embodiments of the present invention, there are provided methods for estimating future product demand by measuring a plurality of factors, calculating correlations between the factors and/or combinations of factors with product demand, and calculating a classifier algorithm to estimate future product demand based on factors and/or combination of factors. By collecting and recording factors and calculating one or more classifier algorithms based on these factors, it is possible to evaluate many more factors and combinations of factors than is possible by human observation and reasoning, and with greater accuracy and consistency.

The terminology to describe the steps in calculating the classifier algorithm varies according to whether statistical or machine learning methodologies are employed. This description uses the terminology from machine learning, but the present invention, in some embodiments thereof, may also use statistical methods.

Equivalent statistical terms are often appended to the definitions of machine learning terms.

The present invention, in some embodiments thereof, is a method of collecting data from a target venue that serves beverages, calculating a classifier algorithm that identifies correlations between product demand and the data, and estimates future product demand based on the correlation.

For example, a variety of sensors may be installed in a restaurant and/or a bar, and/or a chain of restaurants and/or bars. One or more of the sensors generate parameters, referred to herein as local features, during a time period, for example illumination condition changes, audible parameter changes, number of people in the target venue, volume of beer sold, level of sales, temperature within the target venue, temperature outside, complimentary snacks served, and/or other parameters. In statistical methodology, features are referred to as independent variables and/or explanatory variables.

In addition to the local features, non local features may also be collected. Non local features may comprise parameters collected from remote target venues, for example a chain of target venues, from competitors, and/or a group of collaborating independent target venues. In addition to local and non local features, general conditions may be collected, for example time of day, day of week, month of the year, and/or any other general condition. The local features, non local features, and general conditions, referred to herein as features, and/or a subset thereof, may be collected into a plurality of feature vectors corresponding to time segments of the period.

A plurality of feature vectors, referred to herein as a training set, comprises a data set from which correlations between features vectors and levels of sales may be calculated.

An algorithm, referred to herein as a statistical classifier, may be calculated that estimates product demand based on the correlation between the training set and the level of sales.

The present invention, in some embodiments thereof, may be used to select levels of features to optimize sales in a target venue that serves beverages. For example, a classifier algorithm may estimate a correlation between illumination levels and the percentage of people who enter the target venue who choose to stay and make a purchase. For another example, the classifier algorithm may estimate a correlation between a number of people in a target venue and the amount of purchases by customers already in the target venue.

By calculating one or more classifier algorithms, the owners of the target venue may identify the features and/or combination of features most correlated with maximized sales according to different circumstances. The present invention, in some embodiments thereof, enables owners to make decisions to change factors that can be controlled to match the calculated correlation with maximum sales for each circumstance. For example, when the number of customers is less than 50% capacity, owners may choose to set lighting and sound to levels correlated with new customers choosing to stay, and when the number of customers is greater than 50% capacity, the lighting and sound levels may be set to different levels correlated with maximum sales levels from existing customers.

Before explaining at least one embodiment of the invention in detail, it is to be understood that the invention is not necessarily limited in its application to the details of construction and the arrangement of the components and/or methods set forth in the following description and/or illustrated in the drawings and/or the Examples.

The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

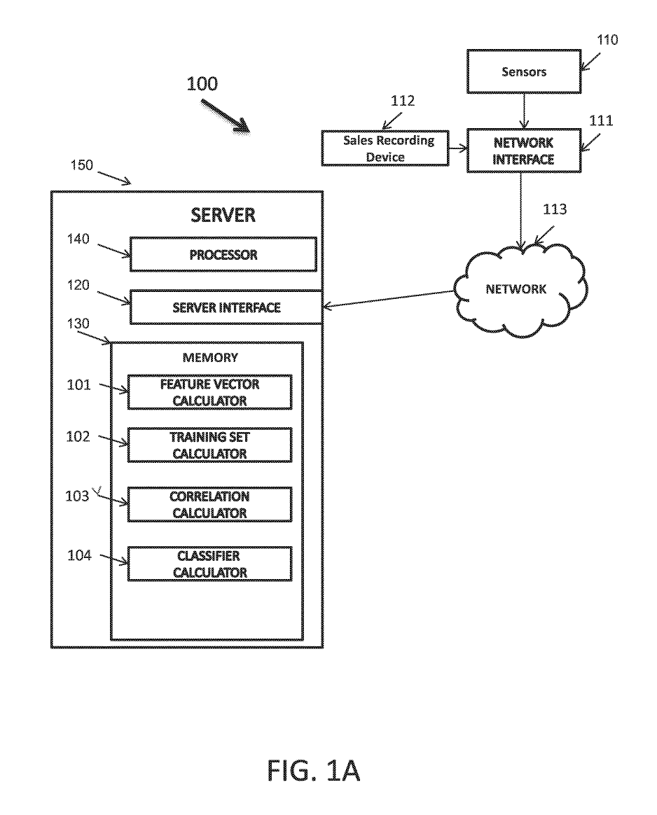

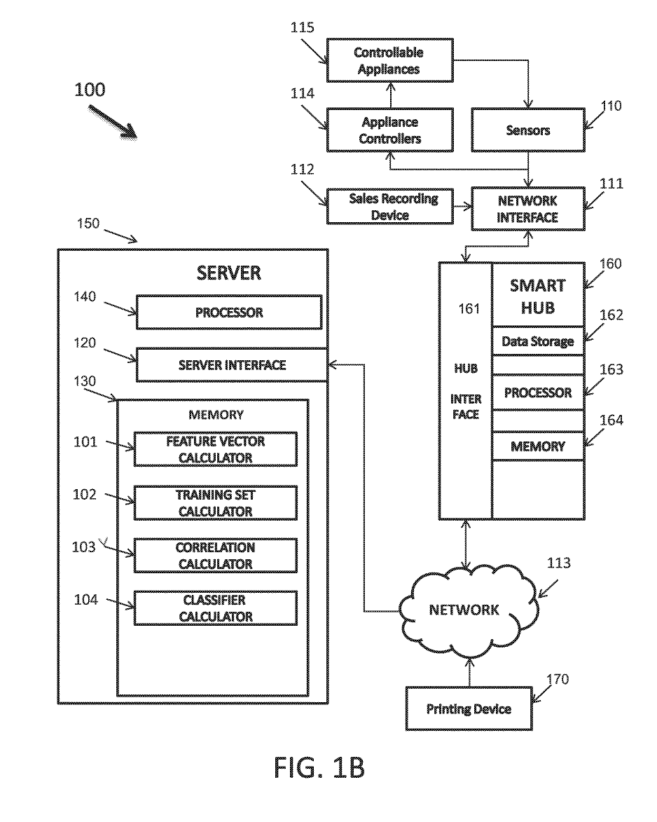

Reference is now made to FIG. 1A, a schematic illustration of an exemplary system 100 for estimating product demand at a target venue, and/or a plurality of target venues, according to some embodiments of the present invention. As shown in 110, a plurality of sensors transmit signals via network interface 111 and/or network 113 to server 150. The sensor signals may be analog signals and/or digital signals.

The digital signals may be transmitted on a serial and/or a parallel networking conduit.

Network interface 111 receives signals from plurality of sensors 110 and/or sales recording device 112 and transmits digital parameters, referred to herein as features, using networking protocols via network 113. Network interface 111 may comprise an analog to digital converter, a digital repeater, a digital data format converter, and/or any other device for receiving sensor signals and/or transmitting the signals over a digital network. For example, sensor 110 may receive and/or transmit signals on a Universal Serial Bus (USB) to network interface 111 which may convert the protocol from USB data to Ethernet (IEEE 802.3).

Optionally, network interface 111 supports all networking protocols that are supported by network 113 described below.

Optionally, network interface 111 may be integrated within a sensor and/or a sales recording device, wherein the features are transmitted directly to network 113. Network 113 may be any type of data network, for example, a local area network (LAN), a wireless LAN, a wide area network (WAN), or the connection may be made to an external computer, for example through the Internet using an Internet Service Provider (ISP) and/or any other type of computer network. The wireless LAN may use one or more wireless protocols, including Bluetooth, Bluetooth low energy (BLE), 802.11 compliant wireless local area network (WLAN), and/or any other wireless LAN protocol.

Network 113 may use networking protocols, for example Transmission Control Protocol and Internet Protocol (TCP/IP), Asynchronous Transfer Mode (ATM), asymmetric digital subscriber line (ADSL), and/or any other networking protocol. Network 113 may comprise one or more routers, wireless routers, hubs, smart hubs, switches, smart switches, and/or any other type of networking equipment.

Optionally, sensors 110 comprise audible level sensors, illumination level sensors, air quality sensors, sensors which indicate a change in the number of people in said target venue, liquid dispenser volume sensors, temperature sensors, a sensor detecting a media channel or web site displayed on a monitor, and/or any other type of sensor that detects any aspect of human activity or interaction. In addition, sensors 110 may comprise general condition sensors, for example time of day, day of week, month of year, calendar holiday, weather conditions, and/or any other type of general condition sensor. Sensors 110 may be located at a single target venue, or at a plurality of target venues.

Optionally, sensors 110 which indicate a change in the number of people in the target venue may comprise image sensors, video sensors, voice sensors, thermal sensors, wireless sensors for recognizing a mobile communication device, and/or any other type of sensor for automatically identifying a person.

Optionally, some or all of sensors 110 may time stamp corresponding output signals.

Optionally, sensors 110 comprises capabilities to record to a computer data file a log of sensor outputs over a period of time, and the ability to transmit the computer data file to server 150 and/or smart hub 160, for example via network 113.

Sales recording device 112 reflects product demand, and is transmitted via network 113 to server 150, either directly or via network interface 111. Optionally, the sales recording device may be one or more point of sales (POS) devices, electronic cash registers, computers recording an ecommerce transaction, cell phones recording a cell phone transaction, credit card reading devices, smart credit cards, and/or any other device that records sales transactions.

Optionally, sales recording device 112 comprises capabilities to record to a computer data file a history of sales activity over a period of time, and the ability to transmit the computer data file to server 150 and/or smart hub 160, for example via network 113. The sales activity recorded to the computer data file may comprise products sold, brand names, quantity, price, discounts, and/or any other details related to the sales transaction.

Optionally, sales recording device 112 records when each individual product was ordered as well as when payment was made.

The level of product demand is a feature, but is distinguished from the other features because a goal of the present invention, in some embodiments thereof, is to calculate a set of features that will result in a desired level of product demand. A desired level of product demand is referred to herein as a class. The statistical term for a class is outcome category. The feature that is defined as a goal, for example a level of product demand, is referred to in statistical terms as a dependent feature.

As shown in server interface 120, the features are received by server 150 from network 112. Server 150 comprises memory 130, one or more processors 140, and server interface 120. Memory 130 is a non-transitory computer readable storage medium for storing code instructions and/or data. Code instructions stored in memory 130 may be divided into functional modules, comprising feature vector calculator 101, training set calculator 102, correlation calculator 103, and classifier calculator 104. Processor 140 is connected to memory 130 and to interface 120.

Interface 120 transmits received features to feature vector calculator 101.

Optionally, interface 120 may receive a plurality of features comprising a computer data file, for example from a sales recording device.

As shown in memory 130, feature vector calculator 101 comprises code instructions that when executed time stamp and/or organize the features into a plurality of feature vectors.

Each feature vector comprises a plurality of time correlated features from sensors 110 and/or sales data recording device 112. For example, one feature vector may contain features from the illumination sensor, the audible level sensor, and sales data, all from time segment 12:00:00 until 12:10:00.

Another feature vector may contain features from the illumination sensor, the audible level sensor, and sales data from the time segment 12:10:00 until 12:20:00.

Optionally, the time segment of the sales data may correspond to when the product was ordered, and/or to when the payment transaction occurred.

Optionally, feature vector calculator 101 comprises code instructions that when executed replaces a plurality of features received from a sensor during a time segment with a representative value. For example, during the time segment 12:10:00 until 12:20:00 the audible level sensor may provide 100 features with values ranging from 10 to 20. Vector calculator 101 comprises code instructions that when executed may replace the 100 features with a single representative feature. The representative feature may be calculated by a mathematical operation, for example mathematical average, median, weighted arithmetic mean, truncated mean, and/or any other method for calculating a representative value from a parameter set.

Optionally, feature vector calculator 101 comprises code instructions that when executed receive user input via server interface 120 to generate the feature vector from a subset of all features. For example, a user may input instructions to include in the feature vector only features from the air quality sensor, the illumination sensor, and the levels of product demand.

Optionally, feature vector calculator 101 comprises code instructions that when executed receive a plurality of features in a computer file, extracts individual feature data from the file, and then generates feature vectors as described above.

Optionally, feature vector calculator 101 comprises code instructions that when executed perform parsing of computer files comprising a plurality of features, categorizes sales data information, and generates new features for the categories. For example, a sales item may be described in a sales feature as “Coors Light”, and the executing code instructions calculate a category for this item, for example “Light Beer”.

New features may be generated from the categories calculated by combining features that belong to the same category, for example a new feature “scotch” may be generated by combining all varieties of single malt scotch and blended scotch that are categorized as “scotch”, and for another example a new feature “snacks” may be generated by combining all varieties of pretzels and peanuts other bar foods that may be categorized as “snacks”, and the like.

Optionally, feature vector calculator 101 comprises code instructions that when executed stores features in a database.

Training set calculator 102 comprises code instructions to receive a plurality of feature vectors from feature vector calculator 101, and save the feature vectors into a computer file, referred to herein as a training set.

Correlation calculator 104 comprises code instructions that when executed calculate a correlation between the training set and the product demand. For example, the training set may comprise 100 feature vectors, and the 10 feature vectors with the highest levels of product demand all have values from the audible level sensors within a certain range, whereas feature vectors with lower levels of product demand have values from the audible level sensors outside of the certain range. Similarly, levels of product demand may be found to be correlated with a combination audible levels and illumination levels.

Identifying correlations between product demand and feature vectors is a first step in calculating a classifier algorithm. Classifier calculator 104 comprises code instructions that when executed receive as input the calculated correlation from the training set, one or more feature vectors from a time period different from the time period of the training set, and a class comprising a desired range of levels of product demand. A classifier algorithm is calculated which when executed estimates product demand levels of the one or more feature vectors from the different time period. For example, the training set may include 100 feature vectors for a time period of 09:00:00 pm till 11:30:00 pm on a certain day. Based on this training set, classifier calculator 104 may calculate a classifier algorithm that when executed estimates what level of product demand will result from a given combination of sensor levels from 09:00:00 pm till 11:30:00 pm on another day.

Optionally, server interface 120 comprises a user interface (UI) which is adapted to allow a user to input instructions to determine factors in calculating the classifier algorithm. For example, the instructions may include choosing a subset of sensors 110 from which to calculate the feature vector, choosing a time period for the training set, choosing a time segment for each of the plurality of feature vectors, choosing a class comprising a range of levels of product demand, specifying one or more said products sold for the calculation of the product demand level, and/or any other instruction that may impact the calculation of the classifier algorithm.

Optionally, the UI of server interface 120 is adapted to allow a user to input features and to transfer these features to feature vector calculator 101, for example types of snacks served, time bound sales promotions, identity of staff at a selling venue, for example a bartender and/or waitress, time bound decorations or displays, a category of music being played through a sound system, a radio station or source of pre-recorded music, a name of an live performing entertainer, source of video media, and/or any other information regarding the target venue.

Optionally, server interface 120 is adapted to receive data from remote computer servers and to transfer this data as features to feature vector calculator 101, for example prices of products offered for sale at other target venues and/or competitors, volume of sale of specific products at other target venues and/or competitors, weather conditions, news events, sports events, words, names, phrases and/or events trending on social media networks, customer interactions with a wireless local area network (WLAN), and/or any other data received from a remote server.

Optionally, the UI of server interface 120 is adapted to receive a computer file comprising a training set. A user may transmit the training set via network 113 to server 150. Correlation calculator 103 may contain code instructions to receive the training set from server interface 120, and to calculate a correlation in the same manner as a training set received from training set calculator 102.

Reference is now made to FIG. 1B, a schematic illustration of exemplary system 100 with an optional smart hub 160, printing device 170, and/or optional appliance controllers 114, according to some embodiments of the present invention.

Optionally, appliance controller 114 may have an interface to network interface 111, smart hub 161, and/or network 113, and may support the networking protocols described above for network 113. Appliance controllers 114 may connect directly to controllable appliances 115, using any of the networking communications protocols described above, and/or may connect to controllable appliances via network interface 111.

Optionally appliance controllers 114 may comprise any type of automatic and/or manual control device and/or control system, for example open loop, closed loop, programmable digital timer, programmable logic controllers, linear control, non-linear control, digital and/or discrete control, single input single control, multiple input multiple control, lumped parameter, and/or distributed parameter.

Optionally, controllable appliances 115 are located at the target venue, and may comprise any appliance that may be controlled automatically by a connection to a controller device. For example, controllable appliances may be a lock on a cash register, a lock on a refrigerator door, a shut off flow valve on a liquid dispenser device, an illumination device, a sound system, a computerized menu of products, a computerized product price list, and/or a video display system.

Optionally, printing device 170 comprises an electronic printer adapted to printing a computer file received via network 113 from a computing device, for example server 150, sales recording device 112, and/or smart hub 160. The computer files may comprise sales data from sales recording device 112 and/or outputs from sensors 110 as described above. Printing device 170 may comprise a computer driver software that when executed performs optical character recognition (OCR) on the received sales data computer file, and generates a computer file comprising encoded text characters, for example American standard code for computer interchange (ASCII) characters. Printing device 170 may transmit the generated text computer file to server 160 and/or hub 161.

Optionally, sensors 110 and/or sales recording device 112 may transmit features to a computing device, for example server 150, smart hub 160 and/or any other computer platform adapted to receive and transmit computer data on network 113. The computing device collects the sales data into a computer file, and is adapted to transmit the computer data file to server 150 and/or smart hub 160.

Optionally, smart hub 160 comprises hub interface 161, data storage 162, one or more processors 163, and memory 164. Memory 164 is a non-transitory computer readable storage medium for storing code instructions and/or data. Processor 163 is connected to memory 164 and to interface 161. Hub interface 161 may support all network protocols and interfaces as described above in network 113.

Optionally, smart hub 160 may communicate with appliance controllers 115 in a peer-to-peer networking connection. Smart hub 160 may calculate recommended parameter levels as a function of parameters received from sensors 110. The recommended parameter levels may be transmitted to the corresponding appliance controller 114. Processor 163 may calculate code instructions stored in memory 164 to calculate the recommended parameter level.

For example, smart hub 160 may initiate peer-to-peer communication with an appliance controller 114 to lock a controlled cash register, refrigerator door, and/or beer flow shut-off valve at a specified time after the target venue has closed. The control instructions may be sent to appliance controller 115 which initiates a state change in a controllable locking mechanism. For another example, smart hub 160 may initiate a peer-to-peer communication with an appliance controller to raise or lower illumination levels in response to a received parameter of a volume of beer dispensed, and/or to raise or lower prices as a function of the number of people in a target venue.

For another example, smart hub 160 may initiate changes in the prices of products as a function of external events, for example the occurrence of a sporting event, local weather conditions, prices of competitors, holidays, and/or any other external event.

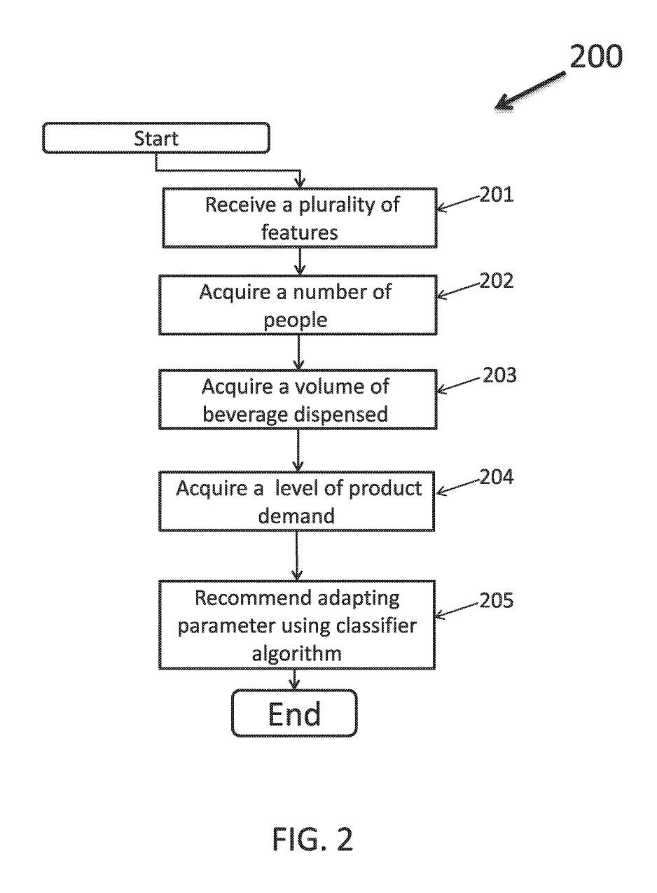

Optionally, smart hub 160 may comprise code instructions stored in memory 130. For example, smart hub 160 may store in memory 164 code instructions comprising feature vector calculator 101, training set calculator 102, correlation calculator 103, and classifier calculator 104. Processor 163 may execute the code instructions stored in memory 164. Smart hub 160 may calculate recommendations for adapting parameter levels in response to a calculated correlation algorithm, as described below in FIG. 2.

The present invention, in some embodiments thereof, may comprise a plurality of controllable display devices, for example individual display devices for each item offered for sale. For example, the target venue may sell packaged items, for example a supermarket, a grocery store, a foodstuffs store, and the like. The controllable appliance 115 may comprise smart price tags, for example low frequency radio frequency (RF) price tag, a radio frequency identification device (RFID), a smart price tag, and/or any other controllable display device.

Reference is now made to FIG. 2, which is a flowchart of an exemplary process 200 for estimating product demand for at least one target venue, according to some embodiments of the current invention. As shown in 201, a plurality of features, comprising local features and general features, is acquired during a time period. The features are acquired from sensors that are installed in at least one target venue, and/or from remote computer servers, and/or from user input. For example, sensors 110 send signals to network interface 111 which transmits features to server 150 via network 113. Optionally, a code executing in feature vector calculator 101 time stamps the features.

The local features are acquired from each sensor and/or combinations of sensors, and indicate parameter changes at the target venue. The parameters comprise at least a level of product demand. The local parameter may also include illumination condition changes, audible parameter changes, air quality parameter changes, change in number of people at the target venue, and/or identity of staff working at the target venue.

Optionally, the sensors may be chosen from a group consisting of, but not restricted to, illumination sensors, audible level sensors, and air quality sensors. In addition to the sensors, other data may be acquired from a data generating devices including a continuous time clock, and/or any other type of sensor as described above in sensors 110.

The general features comprise time of day, date, time limited sales promotions, local weather conditions, and/or any other parameter and/or general condition as described above. For example, the general features may be acquired to server interface 120 from a computer server via network 113.

Optionally, the target venue may be a bar, a restaurant, a kiosk, and/or any other vender of drinks and/or food.

As shown in 202, a change in the number of people in the target venue during the time period is acquired, for example from sensors 110 and transmitted to server 150. The change in number of people may be detected by the output of a sensor adapted to identifying people as described above.

Optionally, the change in the number of people may be computed by analyzing the output of sensors that detect people entering and/or exiting the target venue.

The method of analysis may be chosen from a group consisting of, but not limited to, facial recognition, pattern recognition, voice recognition, shape recognition, color recognition, thermal pattern recognition, wireless recognition of a mobile communication device, and/or any other technology for automatically identifying a person.

Optionally, the recognition technique may identify when a specific person enters the target venue and/or when the same specific person exits the target venue, and further calculate an amount of time each individual spends in the target venue.

This calculation may provide data on how long an average person spends in the target venue, referred to herein as dwell time. The calculation may also provide data on how many people enter and exit within an amount of time too short to have purchased and/or consumed a drink, referred to herein as “bounce rate”.

As shown in 203, a feature is acquired from at least one sensor adapted to detect a volume of liquid dispensed by at least one liquid dispenser during the time period, for example from sensors 110 and transmitted to server 150.

Optionally, features may also be acquired by user input and/or from remote computer servers, for example via server interface 120 as described above.

Optionally, individual sensors detect a volume of different types of liquids.

The types of liquids may comprise a brand of beer, brand of wine, brand of whiskey, brand of spirits, and/or any other type of beverage. For example, individual liquid volume sensors may be installed for each of several different brands of beer.

As shown in 204, data comprising level of product demand at the target venue during the time period is acquired, for example sales recording device 112 may transmit product demand data to server 150. The level of product demand may be time stamped, for example by code executing in feature vector 101.

Optionally, the time stamp of the level of product demand feature may reflect when the product was ordered, and/or when payment was made, for example by code executing in feature vector calculator 101. Optionally, the level of product demand data may comprise product demand data acquired from a sales recording device, for example sales recording device 112 as described above.

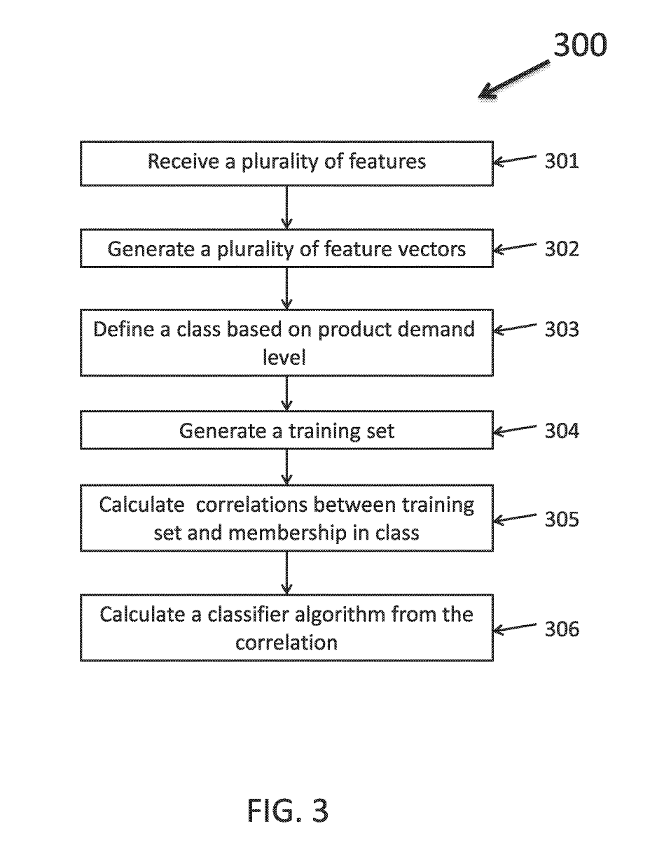

As shown in 205, a recommendation to adapt at least one parameter is calculated by substituting at least one of the features in a classifier algorithm. For example, the calculation may be performed by code instructions from classifier calculator 104 executing on processor 140. A description of the method for calculating the classifier algorithm, and of substituting parameters in the classifier algorithm, is described in FIG. 3 below.

Optionally, a recommendation to adapt at least one parameter is calculated by substituting in the classifier algorithm only the illumination feature, the audible feature, and the number of people feature, and not substituting any other features. The combination of these three features comprises an ambiance parameter, which may be used to correlate consumption with ambiance at the target venue.

Optionally, a recommendation to adapt at least one parameter is calculated by substituting in the classifier algorithm only the number of people feature, the dwell time, and the bounce rate, and not substituting any other features. The combination of these three features comprises an attractiveness parameter, which may be used to correlate consumption with the attractiveness of the target venue.

Optionally, the parameters received from liquid dispenser sensors may be logged over time and used to identify when the target venue has run out of a specific fluid. For example, by comparing liquid volumes of a brand of beer over different time segments, a volume of zero may indicate that the bar had run out of that brand of beer during that time segment.

Optionally, the parameters received from liquid dispenser sensors may be logged over time and used to identify wastage of a liquid. For example, the product demand data for a brand of beer is may be used to estimate a volume of liquid sold.

The estimated volume may be compared to a volume of liquid recorded by liquid flow sensor, and any discrepancies may indicate spillage and/or unrecorded sales.

Optionally, the level of product demand may be limited to a specific product or to a combination of specific products. The level of product demand of the specific product or combination of specific products may be estimated by substituting at least one of the features in the classifier algorithm.

Optionally, classifier calculator 104 may comprise code instructions that when calculated generate a recommended price for one or more products offered for sale as a function of one or more parameters. For example, when a sporting event is occurring, prices of bottled beer may be raised by 20 percent.

For another example, when a competitor lowers a price of a product offered for sale, the price of the same product at the target venue is lowered by a similar amount.

Optionally, the received features are saved in a database, for example in memory 330 and/or in a remote computer storage external to server 200. Future product demand may be estimated by substituting features and/or combinations of features in the classifier algorithm.

Optionally, the recommendation to adapt at least one parameter is automatically implemented by an appliance controller, for example appliance controller 114. For example, when the classifier algorithm outputs a recommendation for a specific level of illumination during a certain time of day, the recommendation is automatically sent to a controlling device connected to at least one illumination appliance. The controlling device may set the output level of the at least one illumination appliance according to the recommendation.

Optionally, a recommended parameter level is calculated as a function of one or more input parameters, and is then automatically implemented. The calculation of the recommendation may be performed by code instructions executing on processor 140, and/or on processor 163 of smart hub 161. For example, when audible level sensors transmit parameters in a certain range, then a recommendation is sent to an appliance controller, for example appliance controller 114, connected to at least one illumination appliance. The appliance controller may set the output level of the at least one illumination appliance according to the recommendation. In another example, the price of one or more products offered for sales is automatically adjusted to a recommended value.

Optionally, the value of the recommendation to adapt at least one parameter is automatically displayed to a display screen, for example a video monitor within the target venue. In one embodiment of the current invention, recommended changes to prices of products offered for sale are automatically displayed on display menus.

Optionally, levels of sales are calculated over a period of time, and items that have increased sales during the period of time are then automatically displayed on a display screen. For example, if a brand of beer has rising sales, and/or higher sales than other brands of beers, and/or any other criteria related to levels of sales, this sales activity is calculated by feature vector calculator 101, and is then transmitted via network 113 to a display monitor at a target venue.

Reference is now made to FIG. 3, which is a flowchart of an exemplary process 300 for calculating a classifier algorithm for estimating product demand for at least one target venue, according to some embodiments of the current invention.

As shown in 301, a plurality of features is received, for example from sensors 110 and/or sales recording device 112 sent via network 113 to server 150.

As shown in 302, the features are arranged into a plurality of feature vectors, for example by code executing in feature vector calculator 101. Optionally, the features are time stamped, for example by code executing in feature vector calculator 101. Each feature vector comprises a time correlated set of features. For example, one feature vector may comprise features from a plurality of sensors recorded during a certain time segment, and another feature vector may comprise features from the plurality of sensors recorded during a different time segment.

Optionally, a representative value is calculated from multiple features within a time segment from the same sensor, as described above.

Optionally, a user may provide instructions, for example by input via server interface 120 received by code executing in feature vector calculator 101, to select a subset of sensors, and only the features from the selected subset are included in the feature vector. For example, the user may select only the illumination sensor and the air quality sensor to be included in the feature vector.

As shown in 303, a class is defined comprising a desired range of product demand levels. Optionally the class may be defined by user input, for example by input via server interface 120 received by code executing in feature vector calculator 101. A desired outcome may be, for example, a level of sales between 70% and 90% of a maximum sales level.

As shown in 304, the plurality of feature vectors, comprising all or the subset of features, is stored in a computer file, referred to herein as a training set. For example, the training set may be generated by executing code in training set calculator 102. The training set, in combination with the defined class, is used in calculating the classifier algorithm, as described below.

As shown in 305, a correlation is calculated between the class and the training set. The correlation is a first step in calculating a classifier algorithm.

As shown in 306, a classifier algorithm is calculated from the calculated correlation, for example by executing code in classifier calculator 104.

A classifier algorithm accepts as input the calculated correlation, one or more feature vectors from a time period different from the time period of the training set, and a class comprising a desired range of levels of product demand. A classifier algorithm is calculated which when executed estimates product demand levels of the one or more feature vectors from the different time period.

Optionally, the classifier algorithm is calculated by supervised machine learning, decision tree, linear classifiers, boosting, Support-Vector Machines, neural networks, nearest neighbor algorithms, statistical classification, statistical regression, logistic regression, pattern recognition, sequence labeling, and/or any other methodology for estimating future product demand levels based on a plurality of parameters correlated with past product demand levels.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant sensors and/or smart hub will be developed and the scope of the term sensors and/or smart hub is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for estimating product demand at one or more target venues, comprising:
receiving a plurality of parameters collected from at least one target venue comprising a plurality of local parameters and at least one general parameter;
said local parameters comprising a level of product demand at said at least one target venue, and at least one member of a group of parameters consisting of: a volume of liquid beverage dispensed by at least one liquid dispenser, illumination conditions, audible conditions, number of people in said target venue, and identity of staff working at said target venue;
said general parameter comprising at least one member of a group of parameters consisting of: time of day, date, and local weather conditions;
substituting at least one said parameter in a classifier algorithm, said classifier algorithm calculated to correlate a desired level of said demand for products with said at least one parameter; and
said classifier algorithm outputting a recommendation to adapt said at least one parameter to increase said product demand.

2. The method of claim 1, wherein said classifier algorithm comprises an algorithm for estimating product demand, said algorithm comprising at least one technique chosen from a set of techniques consisting of supervised machine learning, decision tree, linear classifiers, boosting, Support-Vector Machines, neural networks, nearest neighbor algorithms, logistic regression, statistical classification, statistical regression, pattern recognition, sequence labeling, and any other technique for estimating product demand levels based on a plurality of parameters correlated with product demand in the past.

3. The method of claim 1, wherein said target venue is at least one type of business chosen from a group of businesses comprising a bar, a restaurant, a kiosk, a supermarket, a grocery store, a foodstuffs store, and any other vender that offers for sale edible products.

4. The method of claim 1, further comprising calculating an ambiance parameter, said calculation responsive to said illumination conditions, said audible conditions, and said number of people, and further estimating product demand level by substituting said ambiance parameter in said classifier algorithm.

5. The method of claim 1, wherein said liquid comprises at least one liquid chosen from at least one group of liquids, said groups comprising brands of beer, brands of wine, brands of whiskey, brands of spirits, and any other beverage.

6. The method of claim 1, wherein said level of product demand comprises at least one form of sales data chosen from a group of sales data consisting of point of sales (POS), cash register records, written receipts, ecommerce transactions, cell phone enabled purchases, smart credit card purchases, and any other record of sales transactions.

7. The method of claim 1, wherein said levels of product demand comprises time stamped records of payment for products purchased and records of when said purchased products were ordered.

8. The method of claim 1, wherein said change in number of people is calculated automatically by acquiring and analyzing output of a sensor indicative of a change in the number of people, wherein recognition techniques are employed to identify individuals, employing at least one technique from a group of techniques comprising facial recognition, pattern recognition, voice recognition, shape recognition, color recognition, thermal recognition, wireless recognition of a mobile communication device, and any other technology for automatically identifying a person.

9. The method of claim 8, further comprising a using said recognition technique to calculate an amount of time each individual dwells in said target venue.

10. The method of claim 9, further comprising calculating an attractiveness parameter, said calculation responsive to said change in number of people and said amount of time individuals dwell, and further estimating product demand level by substituting said attractiveness parameter in said classifier algorithm.

11. A method of claim 1, wherein a state transition corresponding to said at least one parameter recommendation is automatically initiated for at least one controllable appliance, said controllable appliance located at said at least one target venue.

12. A method of claim 1, wherein a state transition corresponding to a recommendation output by a control algorithm is automatically initiated for at least one said controllable appliance, said control algorithm correlating said state transition with a range of values of at least one said parameter.

13. A method of claim 11, wherein said at least one controllable appliance chosen from a group of appliances that have a plurality of states that may be controlled remotely, consisting of a cash register lock, a refrigerator door lock, a shut off flow valve of said liquid dispenser, an illumination device, a sound system device, a smart price tag, a low frequency radio frequency smart price tag, a computerized menu of prices for products, and any other controllable appliance in said local venue.

14. A method of claim 1, wherein more than one parameter of said plurality of local parameters may be automatically defined as belonging to a category, said category comprising a new local parameter.

15. A method for calculating a classifier algorithm for estimating product demand at one or more target venues, comprising:
receiving a training set comprising a computer file, said computer file comprising a plurality feature vectors;
each of said plurality of feature vectors comprising a plurality of features comprising parameters collected from sensors at one or more target venues during a time segment of certain period;
said plurality of features comprising at least one member of a group consisting of illumination condition changes, audible parameter changes, time of day, time limited sales promotions, air quality changes, a plurality of liquid consumption changes from at least one liquid dispenser; and levels of product demand from customers of at least one product offered for sale;
defining a subset of said plurality of features, and adjusting said feature vector to include only said subset of said plurality of features;
defining at least one class comprising a set of all feature vectors with corresponding said product demand level less than a maximum and greater than a minimum level;
calculating from said training set a correlation between at least one said feature vector and said class; and
calculating a classifier algorithm that estimates, based on said correlation, when a feature vector from a time segment of another period is a member of at least one said class.

16. The method of claim 15, wherein said classifier algorithm comprises an algorithm for estimating product demand, said algorithm comprising at least one technique chosen from a set of techniques consisting of supervised machine learning, decision tree, linear classifiers, boosting, Support-Vector Machines, neural networks, nearest neighbor algorithms, logistic regression, statistical classification, statistical regression, pattern recognition, sequence labeling, and any other technique for estimating product demand levels based on a plurality of parameters correlated with past levels of product demand.

17. The method of claim 15, further comprising a user input of instructions for said calculation of said classifier algorithm, said instructions comprising at least one member chosen from a list consisting of: choosing a subset of said plurality of features from which to calculate said feature vector, choosing a time period for said training set, choosing a time segment for each of said plurality of feature vectors, choosing a said minimum and maximum sale level of said class, and defining said product demand to measure only a specific said product sold or a specific group of said products sold.

18. A system for estimating product demand at one or more target venues, comprising:
a plurality of sensors deployed at one or more target venues;
at least one sales recording device adapted to recording product demand at one or more target venues;
at least one network interface device adapted to receive signals from said plurality of sensors and said sales recording device and transmit said signals as parameters;
at least one server comprising:
an interface adapted to acquiring and time stamping a plurality of parameters from said plurality of sensors located at or near said one or more target venue;
said server interface adapted to acquiring a plurality of product demand data from said at least one said sales data recording device;
one or more non-transitory computer-readable storage mediums;
code instructions stored on at least one of said one or more storage mediums;
one or more processors for executing said code instructions coupled to said interface and coupled to said one or more storage mediums, said code instructions comprising:
code instructions for storing said plurality of parameters and said plurality of product demand data in a computer file as plurality of time stamped parameter vectors, wherein said plurality of parameters and product demand data belong to a corresponding time segment;
code instructions for identifying at least one correlation between said level of product demand and at least one of said plurality of parameters in said computer files;
code instructions to calculate a classifier algorithm to estimate product demand based on said correlation; and
code instructions for said classifier algorithm to output a recommendation to adapt said at least one of said plurality of parameters to increase said product demand.

19. The system of claim 18, wherein said sensors comprise at least one member of a group consisting of audible level sensors, illumination level sensors, air quality sensors, sensors which indicate a change in the number of people in said one or more target venues, and liquid dispenser volume sensors.

20. The system of claim 18, wherein said interface comprising a user interface (UI) allowing a user to input instructions to determine calculation of said classifier algorithm, said instructions comprising at least one member chosen from a list consisting of: choosing a subset of said plurality of parameters from which to calculate said correlation, choosing a time period for said training set, choosing a time segment for each of said plurality of parameter vectors, choosing a range of said levels of product demand from which to calculate said correlation, and choosing said product demand level to include only a specific product or a specific group of products sold.
